(19) United States
(12) Patent Application Publication
(10) Pub. No.: US 2025/0153198 A1
(43) Pub. Date: May 15, 2025

(54) Garden Hose Nozzle

(71) Applicant: SHIN TAI SPURT WATER OF THE GARDEN TOOLS CO., LTD., Changhua County (TW)

(72) Inventor: Chin-Yuan Chen, Changhua County (TW)

(73) Assignee: SHIN TAI SPURT WATER OF THE GARDEN TOOLS CO., LTD., Changhua County (TW)

(21) Appl. No.: 18/508,215

(22) Filed: Nov. 13, 2023

(51) Int. Cl. B05B 1/16; B05B 1/06; B05B 1/18

(52) U.S. Cl. CPC B05B 1/1654; B05B 1/06; B05B 1/185

(57) ABSTRACT

A garden hose nozzle includes a hose nozzle body, a water guide base, a sprinkler cover, and a drainage plate. The hose nozzle body includes a water outlet channel, the water guide base has a water flow channel running through it. The sprinkler cover has an annular wall and a panel. The panel is provided with a first annular shower area, a middle part, and a second annular shower area. The sprinkler cover is provided with several casings attached to the middle part. The drainage plate is provided with a plurality of circulation holes and extends out a first water conduit and a second water conduit. The first water conduit has at least one first opening and is provided with a first water retaining plate on the outside. The second water conduit has at least one second opening and is provided with a second water retaining plate on the inside.

### BACKGROUND OF THE INVENTION

### Field of the Invention

This invention relates to a garden hose nozzle structure that can simultaneously produce water mist output from the outer ring and inner ring.

### Description of the Related Art

The hose nozzles are widely used in gardening spraying or cleaning vehicles and articles. Most of the convention hose nozzles have a hose nozzle body, the front end of the hose nozzle body is provided with a rotating nozzle head, and more than one water outlet is formed on the nozzle head. When the nozzle head is rotated, the effect of changing the shape of water spray can be achieved by changing the shapes of these water outlets. The hose nozzle body is provided with a pressing handle that can be pressed to control the opening or closure of the water.

However, the conventional structure as mentioned above has the following problems in practical applications. The hose nozzle can only change the shape of the water spray through the water outlet, so the number of controllable shapes is not enough.

### SUMMARY OF THE INVENTION

This invention provides a garden hose nozzle, which includes: a hose nozzle body, a water guide base, a sprinkler cover, and a drainage plate. The hose nozzle body includes a water outlet channel, the front of the water outlet channel is enlarged to form a rim. The water guide base has a water flow channel running through it, and a shaft extends out. When the water guide base is combined with the rim, the water flow channel and the water outlet channel can be connected. The sprinkler cover has an annular wall, and the front end of the annular wall is closed with a panel, so that the drainage plate can be combined and fixed on the rear end of the annular wall. There is an axis hole in the center of the panel and the drainage plate so that the sprinkler cover combined with the drainage plate can pivot with the shaft of the water guide base by the axis hole. The panel is provided with a first annular shower area, a middle part, and a second annular shower area arranged in sequence from the outside to the inside. The first annular shower area and the second annular shower area are covered with a plurality of micro-sprinkling holes. The sprinkler cover is provided with several casings attached to the middle part, and the front ends of these casings are respectively penetrated by water spouts that can produce different water splash shapes. The casings are connected by a partition, and two of the partitions are provided with a notch. The drainage plate is provided with a plurality of circulation holes and extends out a first water conduit and a second water conduit. The front ends of the first water conduit and the second water conduit are both closed. The first water conduit has at least one first opening passing through in the direction near the first annular shower area, and is provided with a first water retaining plate on the outside. The second water conduit has at least one second opening passing through in the direction near the second annular shower area and is provided with a second water retaining plate on the inside.

When the drainage plate and the sprinkler cover are combined, in addition to allowing the circulation hole to be connected to the casing, the first water conduit and the second water conduit can be accommodated in the two notches to fill the notches. By rotating the sprinkler cover, the garden hose nozzle can have the functions of the inner ring mist, the outer ring mist, or other different spray shapes formed by different water spouts.

Compared with the conventional hose nozzles, this invention provides a garden hose nozzle structure, which uses the rotation of the sprinkler cover to not only change the shape and water output of the water spray through different water spouts, but also has the functions of the outer ring mist and the inner ring mist. Hence, the invention allows the garden hose nozzle to have more control options to choose from, making it suitable for most occasions. This invention further provides a garden hose nozzle structure. When the outer ring mist and the inner ring mist are selected, the spraying area and spray volume can be greatly increased, so that the garden hose nozzle will not damage the plants by excessively strong water flow.

### BRIEF DESCRIPTION OF THE DRAWINGS

The following drawings are merely examples for illustrative purposes according to various disclosed embodiments and are not intended to limit the scope of the present disclosure.

FIG. 1 is a three-dimensional combination of this invention.

FIG. 2 is a three-dimensional exploded view of this invention.

FIG. 3 is the combined plan view of this invention.

FIG. 4 is a cross-sectional view of the water spout.

FIG. 5 is a rotation state diagram of this invention.

FIG. 6 is a cross-sectional view of the outer ring mist of this invention.

FIG. 7 is a diagram showing the water-guiding state when water comes out of the outer ring mist function.

FIG. 8 is a diagram showing the water-guiding state when water comes out of the inner ring mist function.

### DETAILED DESCRIPTION OF THE INVENTION

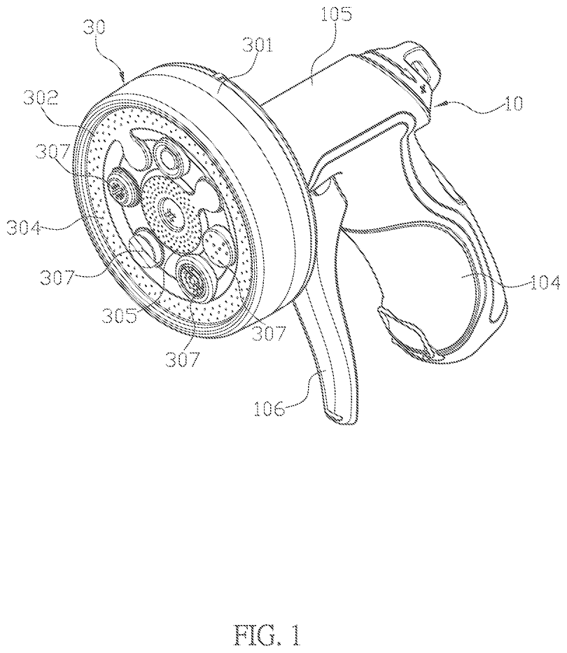

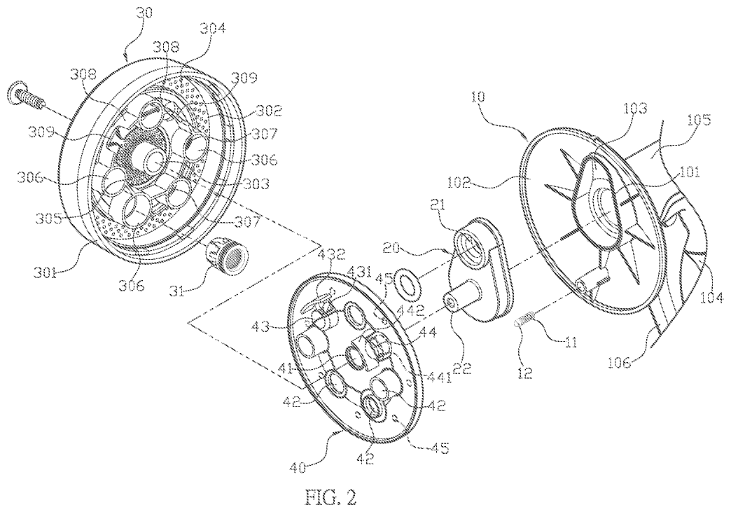

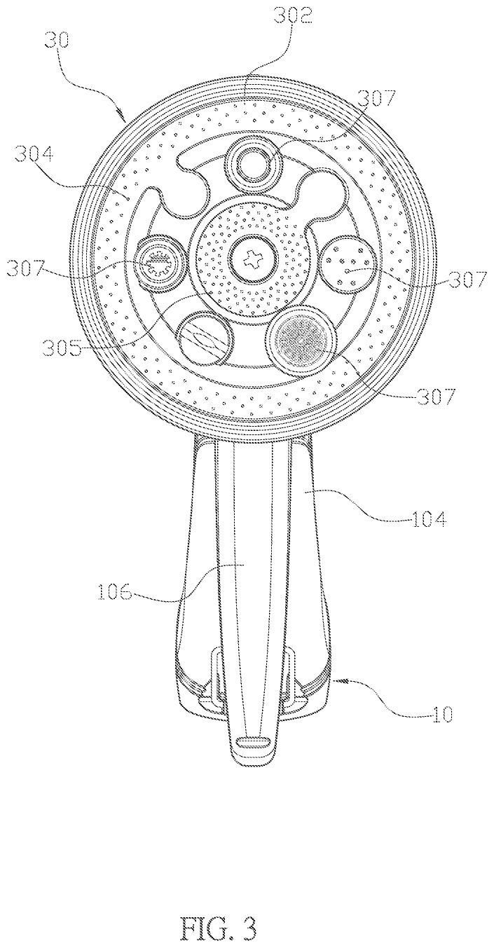

First, as shown in FIGS. 1 to 3, the garden hose nozzle includes a hose nozzle body 10, a water guide base 20, a sprinkler cover 30, and a drainage plate 40. The hose nozzle body 10 includes a water outlet channel 101, the front of the water outlet channel 101 is enlarged to form a rim 102. The water guide base 20 has a water flow channel 21 running through it, and a shaft 22 extends out. When the water guide base 20 is combined with the rim 102, the water flow channel 21 and the water outlet channel 101 can be connected. The sprinkler cover 30 has an annular wall 301, and the front end of the annular wall 301 is closed with a panel 302, so that the drainage plate 40 can be combined and fixed on the rear end of the annular wall 301. There are axis holes 303 and 41 in the center of the panel 302 and the drainage plate 40 so that the sprinkler cover 30 combined with the drainage plate 40 can pivot with the shaft 22 of the water guide base 20 by the axis holes 303 and 41. The panel 302 is provided with a first annular shower area 304, a middle part, and a second annular shower area 305 arranged in sequence from the outside to the inside. The first annular shower area 304 and the second annular shower area 305 are covered with a plurality of micro-sprinkling holes. The sprinkler cover 30 is provided with several casings 306 attached to the middle part, and the front ends of these casings 306 are respectively penetrated by water spouts 307 that can produce different water splash shapes. The casings 306 are connected by partitions 308, and two of the partitions 308 are provided with notches 309. The drainage plate 40 is provided with a plurality of circulation holes 42 and extends out a first water conduit 43 and a second water conduit 44. The front ends of the first water conduit 43 and the second water conduit 44 are both closed. The first water conduit 43 has at least one first opening 431 passing through in the direction near the first annular shower area 304, and is provided with a first water retaining plate 432 on the outside. The second water conduit 44 has at least one second opening 441 passing through in the direction near the second annular shower area 305 and is provided with a second water retaining plate 442 on the inside.

When the drainage plate 40 and the sprinkler cover 30 are combined, in addition to allowing the circulation hole 42 to be connected to the casing 306, the first water conduit 43 and the second water conduit 44 can be accommodated in the two notches 309 to fill the notches 309. By rotating the sprinkler cover 30, the garden hose nozzle can have the functions of the inner ring mist, the outer ring mist, or other different spray shapes formed by different water spouts 307.

The present invention provides a garden hose nozzle structure, wherein, inside the rim 102, a water tank 103 is separated out from the front end of the water outlet channel 101. The groove edge of the water tank 103 is connected to the water guide base 20, so that the water source can be directed to one side and then sent forward from the water flow channel 21.

The present invention provides a garden hose nozzle structure, wherein the hose nozzle body 10 has a grip handle 104 and a barrel part 105 that are connected. The grip handle 104 is used to connect the water source and can be held by the users, and the water outlet channel 101 and the rim 102 are provided on the barrel part 105.

The present invention provides a garden hose nozzle structure, wherein the hose nozzle body 10 is provided with a press handle 106 for pressing, so that the supply of the water source can be controlled by pressing or releasing the press handle 106.

The present invention provides a garden hose nozzle structure, wherein the hose nozzle body 10 is provided with a positioning pin 12 pushed outward by a spring 11. The rear end of the drainage plate 40 is recessed with several positioning holes 45, and the positioning holes 45 are used to accommodate the positioning pins 12 when the sprinkler cover 30 drives the drainage plate 40 to rotate, so that the user can feel the halt of the rotation.

The present invention provides a garden hose nozzle structure, wherein the hose nozzle body 10 and the water guide base 20 are combined by using the high-frequency welding technology.

The present invention provides a garden hose nozzle structure, wherein the sprinkler cover 30 and the drainage plate are combined by using the high-frequency welding technology.

The present invention provides a garden hose nozzle structure, wherein at least one of the casings 306 includes a bubbler 31.

The present invention provides a garden hose nozzle structure, wherein the circulation hole 42 is formed with a flange forward so that the flange can be connected with the casing 306.

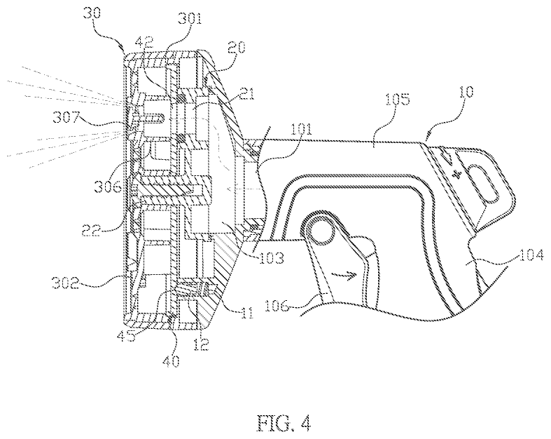

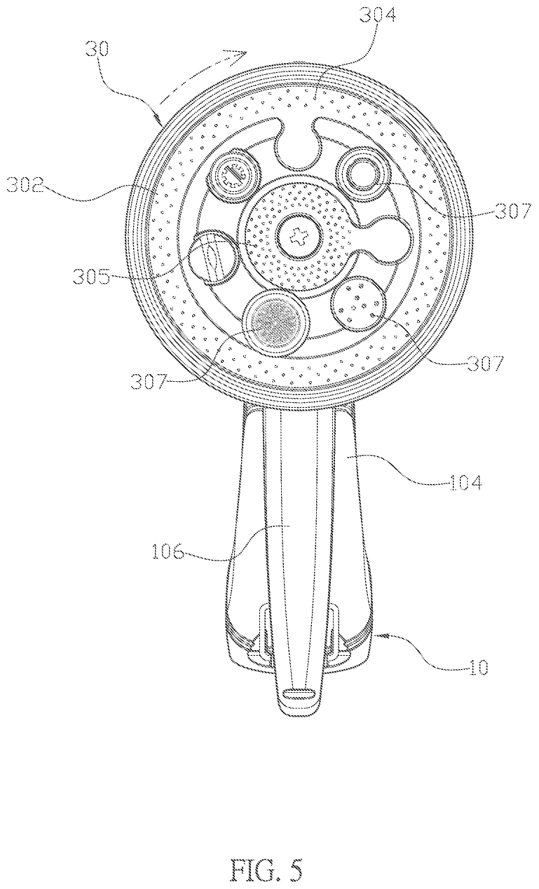

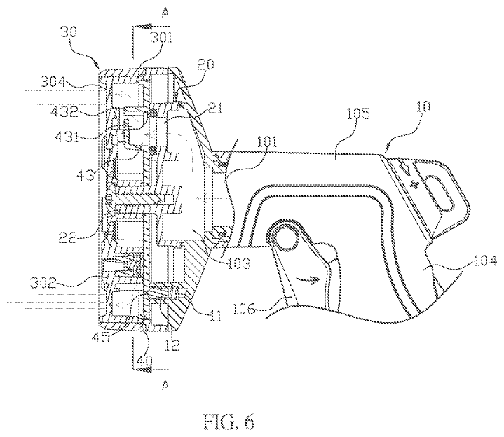

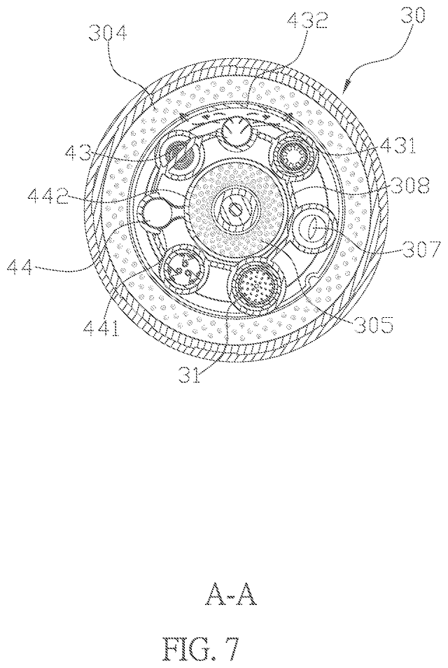

When it is actually used, the rotation of the sprinkler cover 30 drives one of the circulation hole 42 to form an alignment with the water flow channel 21, so that the water flow from the grip handle 104 is sent into the water outlet channel 101, and can flow through the water flow channel 21, the circulation hole 42 and the casing 306, and then flow to the water spout 307 (as shown in FIG. 4). Through the continuous rotation of the sprinkler cover 30, the water spout 307 with different water splash shapes can be selected to spread water. When the sprinkler cover 30 drives the first water conduit 43 to align with the water flow channel 21, water flows out from the first water conduit 43 through the first opening 431 will be guided to the first annular shower area 304 by the first water retaining plate 432, so that the water source can be evenly dispersed in the first annular shower area 304 to achieve the outer ring mist (as shown in FIGS. 5-7).

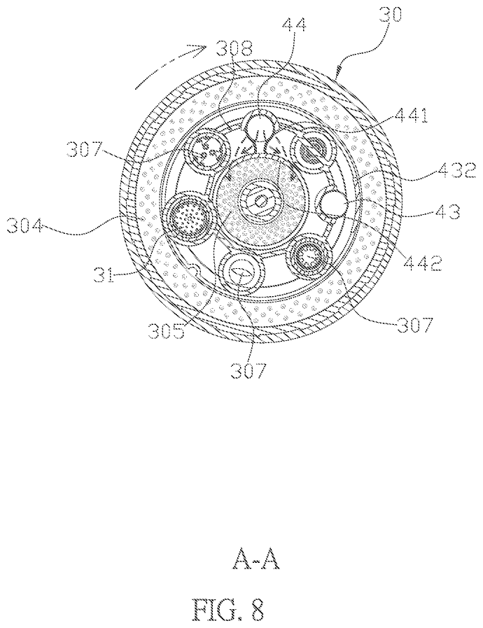

On the contrary, when the sprinkler cover 30 drives the second water conduit 44 to align with the water flow channel 21, the water source flowing out from the second water conduit 44 through the second opening 441 will be guided by the second water retaining plate 442 to the second annular shower area (305), allowing the water source be evenly dispersed in the second annular shower area 305 to achieve the function of water emitting from the inner ring mist surface (as shown in FIG. 8). By having the water flowing through both outer ring mist surface and inner ring mist surface, the water outlet can greatly increase the variety of water outlet sections available for the garden hose nozzle, allowing the garden hose nozzle to be used in more situations and with a wide range of applications.

With the structure of the above-mentioned specific embodiment, the following benefits can be obtained. First, it utilizes the rotation of the sprinkler cover 30 to change the water spray through different water spouts 307. In addition to the shape and water output, it can also have the functions of outer ring mist function and inner ring mist function the same time, so that the number of control sections of the garden hose nozzle can be increased to be suitable for most occasions. Second, when choosing the outer ring mist function and the inner ring mist function, the spraying area and spray volume can be greatly increased, so that the garden hose nozzle will not produce too strong water flow to damage the plants, and it can also be used more economically.

What is claimed is:

1. A garden hose nozzle, comprising a hose nozzle body, a water guide base, a sprinkler cover, and a drainage plate, wherein:
the hose nozzle body comprises a water outlet channel, and a front of the water outlet channel is enlarged to form a rim;
the water guide base has a water flow channel running through and a shaft extending out, when the water guide base is combined with the rim, the water flow channel and the water outlet channel are connected;
the sprinkler cover comprises an annular wall, and a front end of the annular wall is closed with a panel, so that the drainage plate is combined and fixed on a rear end of the annular wall;
an axis hole is formed in a center of the panel and the drainage plate so that the sprinkler cover combined with the drainage plate can pivot with the shaft of the water guide base by the axis hole;
the panel is provided with a first annular shower area, a middle part, and a second annular shower area arranged in sequence from the outside to the inside, the first annular shower area and the second annular shower area are covered with a plurality of micro-sprinkling holes, the sprinkler cover is provided with several casings attached to the middle part, and the front ends of these casings are respectively penetrated by water spouts that can produce different water splash shapes, the casings are connected by a partition, and two of the partitions are provided with a notch;
the drainage plate is provided with a plurality of circulation holes and extends out a first water conduit and a second water conduit, front ends of the first water conduit and the second water conduit are both closed, the first water conduit has at least one first opening passing through in the direction near the first annular shower area and is provided with a first water retaining plate on the outside, the second water conduit has at least one second opening passing through in the direction near the second annular shower area and is provided with a second water retaining plate on the inside, when the drainage plate and the sprinkler cover are combined, in addition to allowing the circulation hole to be connected to the casing, the first water conduit and the second water conduit can be accommodated in the two notches to fill the notches, by rotating the sprinkler cover, the garden hose nozzle can have the functions of the inner ring mist, the outer ring mist, or other different spray shapes formed by different water spouts.

2. The garden hose nozzle of claim 1, wherein, inside the rim, a water tank is separated out from the front end of the water outlet channel, a groove edge of the water tank is connected to the water guide base, so that the water source can be directed to one side and then sent forward from the water flow channel.

3. The garden hose nozzle of claim 1, wherein the hose nozzle body is provided with a positioning pin pushed outward by a spring, the rear end of the drainage plate is recessed with several positioning holes, and the positioning holes are used to accommodate the positioning pins when the sprinkler cover drives the drainage plate to rotate, so that the user can feel the halt of the rotation.

4. The garden hose nozzle of claim 1, wherein the hose nozzle body and the water guide base are combined by using a high-frequency welding technology.

5. The garden hose nozzle of claim 1, wherein the sprinkler cover and the drainage plate are combined by using a high-frequency welding technology.

6. The garden hose nozzle of claim 1, wherein at least one of the casings includes a bubbler.

7. The garden hose nozzle of claim 1, wherein the circulation hole is formed with a flange extending forward so that the flange can be connected with the casing.
